(19) United States
(12) Patent Application Publication
(10) Pub. No.: US 2014/0069979 A1
(43) Pub. Date: Mar. 13, 2014

(54) Fiber Cleaving Tool

(71) Applicant: Panduit Corp., Tinley Park, IL (US)

(72) Inventor: Mateusz Kruzel, Orland Park, IL (US)

(73) Assignee: Panduit Corp., Tinley Park, IL (US)

(21) Appl. No.: 14/024,088

(22) Filed: Sep. 11, 2013

Related U.S. Application Data
(60) Provisional application No. 61/700,440, filed on Sep. 13, 2012.

(51) Int. Cl. G02B 6/25

(52) U.S. Cl. CPC G02B 6/25
USPC 225/1; 225/103

(57) ABSTRACT

The present invention is directed to a fiber cleaving tool that cleaves a fiber optic cable flush with the ferrule's end face. The fiber cleaving tool has a tool body with a tensioning mechanism and a cleaving mechanism. A handle extends from one end of the tool body and a lever is pivotally connected to the opposite end of the tool body. The lever has a trigger blade that activates the cleaving mechanism to cleave the fiber optic cable extending from a connector positioned in the tool body.

### CROSS REFERENCE TO RELATED APPLICATION

This application claims priority to U.S. Provisional Application No. 61/700,440, filed Sep. 13, 2012, the subject matter of which is herein incorporated by reference in its entirety.

### FIELD OF THE INVENTION

The present invention relates to a fiber cleaving tool, and more particularly to a fiber cleaving tool that engages a ferrule end face while cleaving the fiber optic cable extending from the ferrule in a connector.

### BACKGROUND OF THE INVENTION

It is well known to cleave a fiber extending from a ferrule in a connector. Prior fiber cleaving tools, however, have not achieved cleaving a fiber flush or recessed within 100 microns of the ferrule's end face.

FIG. 1 illustrates a prior tool 20 where the ferrule 22 of a connector is inserted into a hole in a ferrule holder. The front face of the connector body 24 is pressed against the connector plate 26 and the end face 23 of the ferrule 22 protrudes through the connector plate 26. The cleaving blade 28 moves in a direction perpendicular to the fiber 30 and a direction axial to the fiber 30 when the tool is actuated. The cleaving blade 28 may move too far in the direction axial to the fiber thereby missing the end face of the ferrule 22. Also, the ferrule 22 often pitches or tilts causing the cleaving blade 28 to contact the side of the ferrule 22.

U.S. Pat. No. 6,695,191 discloses another prior art fiber cleaving tool where the ferrule is installed in an opening in a housing. The end face of the ferrule abuts a stop shelf or a shoulder and a blade is positioned below the edge of the shoulder. The blade propagates a crack in the fiber below the shoulder. Once the blade cracks the fiber, the tool bends the fiber to continue to propagate the crack in the fiber at a distance from the ferrule's end face.

Although the prior art tools cleave the fiber extending from the connector, the tools fail to ensure a flush cutoff. It is important that the fiber optic cable is cleaved flush or recessed within 100 microns of the ferrule end face for an acceptable transmission. As such, it is desirable to provide a fiber cleaving tool that assures that the cleaving blade scores the fiber optic cable flush with the ferrule's end face.

### SUMMARY OF THE INVENTION

The present invention is directed to a fiber cleaving tool that scores a fiber optic cable flush with the ferrule's end face. The tool has a body with a pocket that receives a connector and connector snaps that extend over the pocket to retain the connector in the tool body. A handle extends from a first end of the tool body. A lever is pivotally connected to a second end of the tool body. The tool also includes a tensioning mechanism and a cleaving mechanism. The lever has a blade trigger that activates the cleaving mechanism to cleave the fiber optic cable extending from the connector positioned in the tool.

### BRIEF DESCRIPTION OF THE DRAWINGS

FIG. 1 is a cross-sectional view of a prior art fiber cleaving tool.

FIG. 2 is a perspective view of the fiber cleaving tool of the present invention.

FIG. 3 is a perspective view of a connector with fiber extending out of the ferrule prior to installation in the fiber cleaving tool of FIG. 2.

FIG. 4 is a bottom front perspective view of the fiber cleaving tool of FIG. 2 with the connector of FIG. 3 positioned therein.

FIG. 5 is a back perspective view of the fiber cleaving tool of FIG. 4.

FIG. 6 is an exploded view of the fiber cleaving tool of FIG. 2 with the connector of FIG. 3.

FIG. 7 is a perspective view of the cleaving mechanism of the fiber cleaving tool of FIG. 4.

FIG. 8 is a side view of the fiber cleaving tool of FIG. 4 prior to the lever being activated.

FIG. 9 is a top view of the fiber cleaving tool of FIG. 8.

FIG. 10 is a cross-sectional view of the fiber cleaving tool of FIG. 8 taken along line 10-10.

FIG. 10A is an enlarged view of the cutting mechanism of the fiber cleaving tool of FIG. 10.

FIG. 11 is a cross-sectional view of the fiber cleaving tool of FIG. 9 taken along line 11-11.

FIG. 12 is a bottom perspective view of the fiber cleaving tool of FIG. 4 with the lever activated.

FIG. 13 is a top view of the fiber cleaving tool of FIG. 12.

FIG. 14 is a cross-sectional view of the fiber cleaving tool of FIG. 13 taken along line 14-14.

FIG. 15 is a cross-sectional view of the fiber cleaving tool of FIG. 14 taken along the line 15-15.

FIG. 15A is an enlarged view of the cutting mechanism of the fiber cleaving tool of FIG. 15.

FIG. 16 is a cross-sectional view of the fiber cleaving tool of FIG. 15 taken along line 16-16.

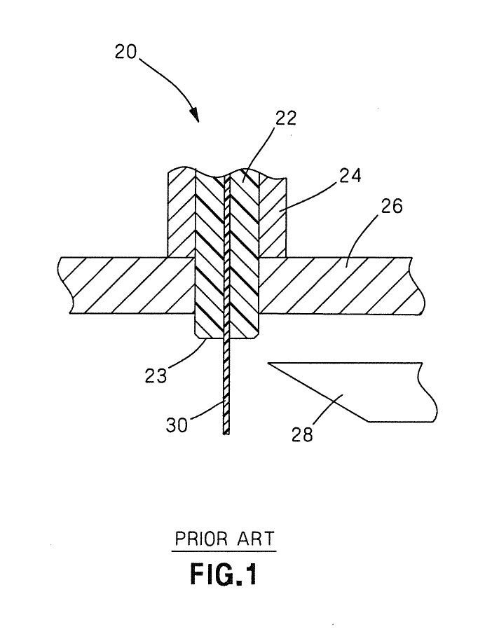

### DETAILED DESCRIPTION

The present invention is directed to a tool that cleaves the plastic clad silica (PCS) fiber optic cable from a connector for industrial automation.

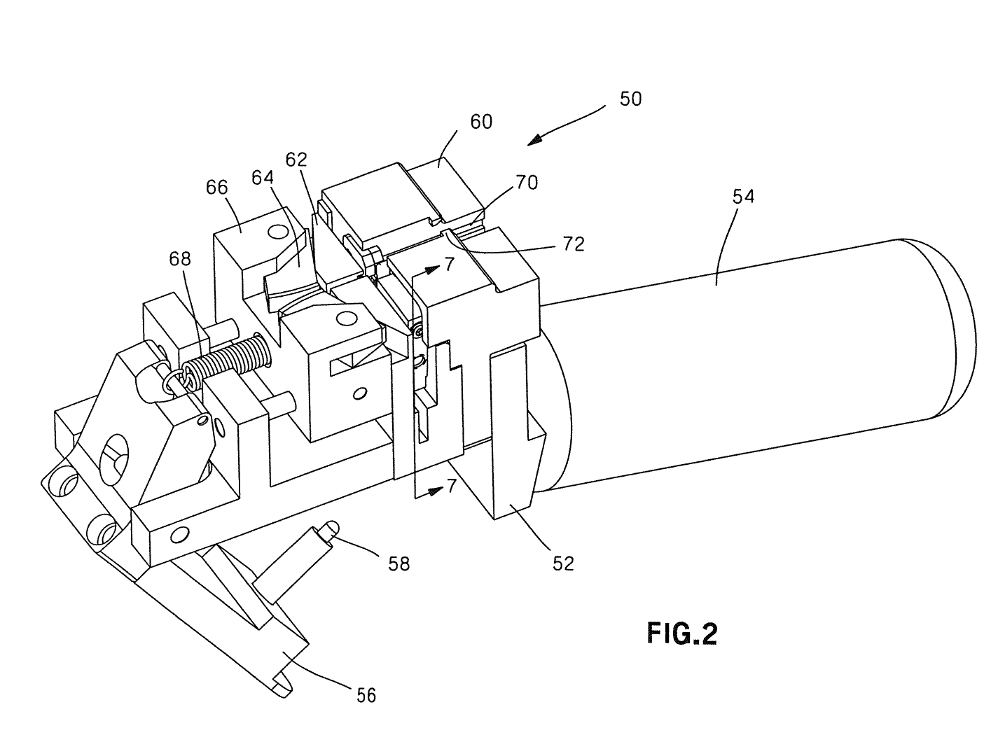

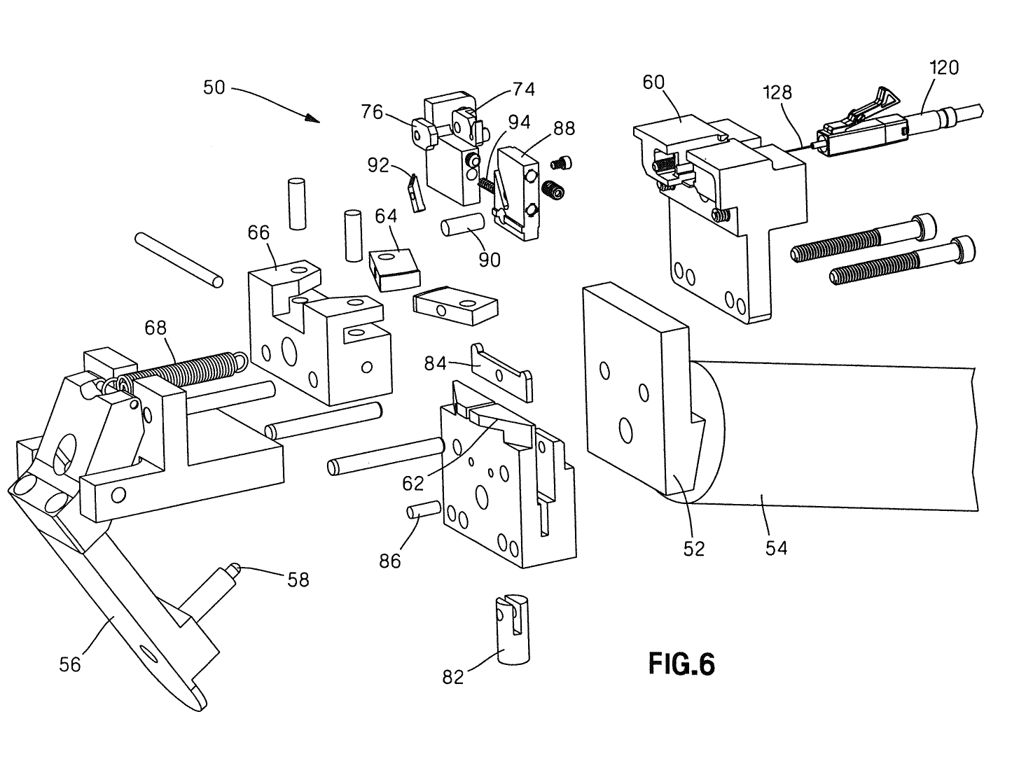

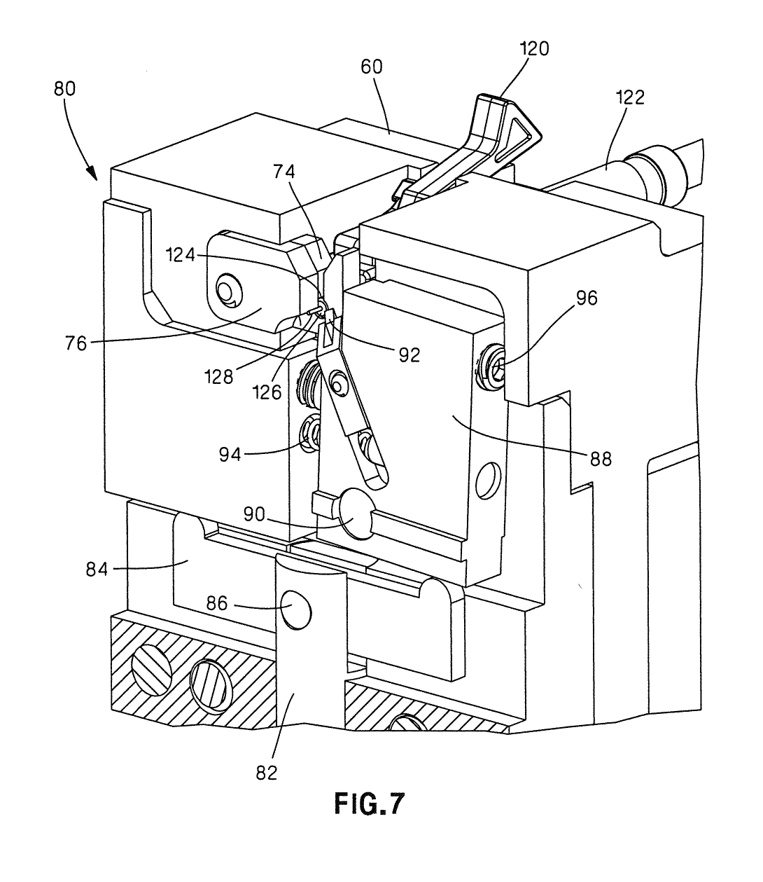

As illustrated in FIGS. 2 and 4-6, the fiber cleaving tool 50 includes a tool body 52 with a handle 54 on one end and a lever 56 pivotally connected at the opposite end. The tool body 52 includes a backbone 60, gripper opener cams 62, grippers 64, a gripper carriage 66 and a spring 68. The lever 56 includes a blade trigger 58 that engages the cleaving mechanism 80 when the lever 56 is activated (see FIG. 7).

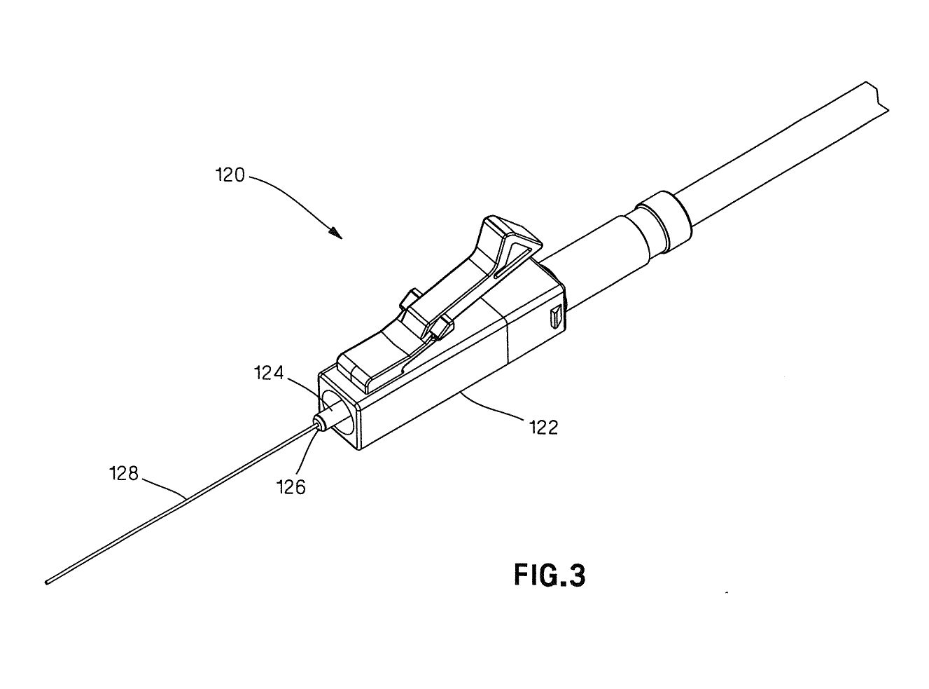

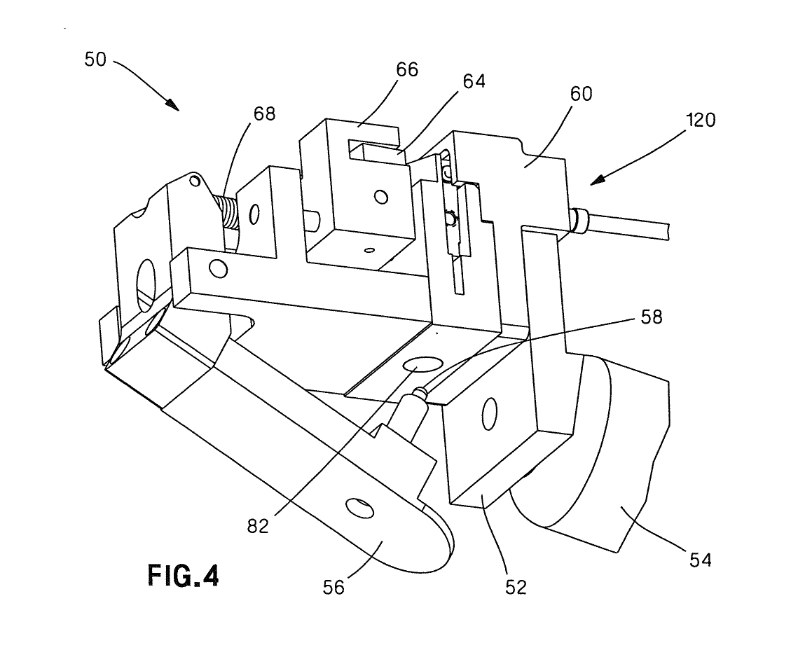

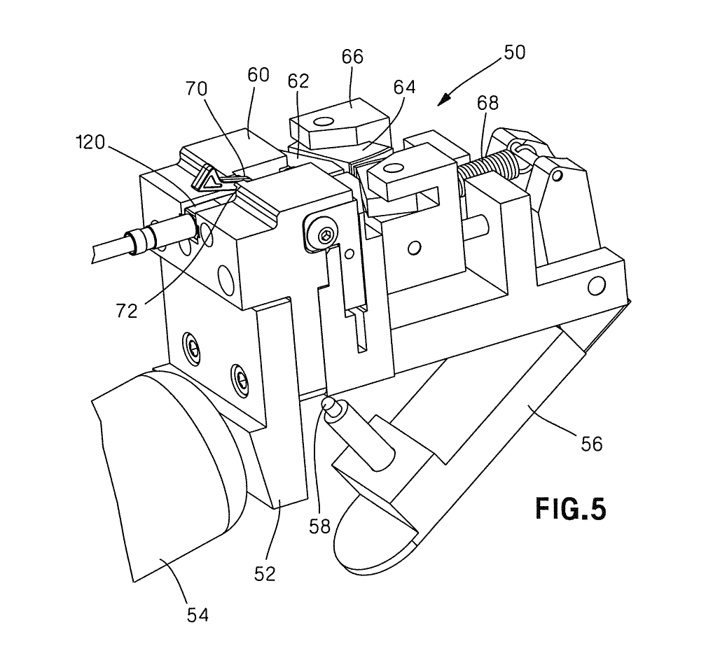

FIG. 3 illustrates a connecter 120 with a connector body 122 and a fiber optic cable 128 extending from the ferrule 124 positioned within the connector body 122. As illustrated in FIG. 5, the connector 120 is positioned in a pocket 70 in the backbone 60 of the fiber cleaving tool 50. The connector snaps 72 engage the connector 120 to hold the connector 120 in place in the tool body 52.

As illustrated in FIG. 7, once the connector 120 is installed in the tool 50, the ferrule 124 is positioned in the ferrule holder 74 and stops at the ferrule stop plate 76. The end face 126 of the ferrule 124 abuts the ferrule stop plate 76 and the end face 126 is flush with the ferrule holder 74. The placement of the connector 120 in the tool 50 assures that the ferrule end face 126 is secured at a known location. The blade holder 88 is adjusted in both the forward and reverse direction, however, reverse travel is controlled by the reverse travel set screw 96 (see FIG. 7) such that the cleaving blade 92 never completely disengages the ferrule 124. Once the connector 120 is inserted in the tool 50, the cleaving blade 92 is on the ferrule end face 126 and ready to start cleaving. Thus, the cleaving blade 92 is in constant contact with the ferrule end face 126.

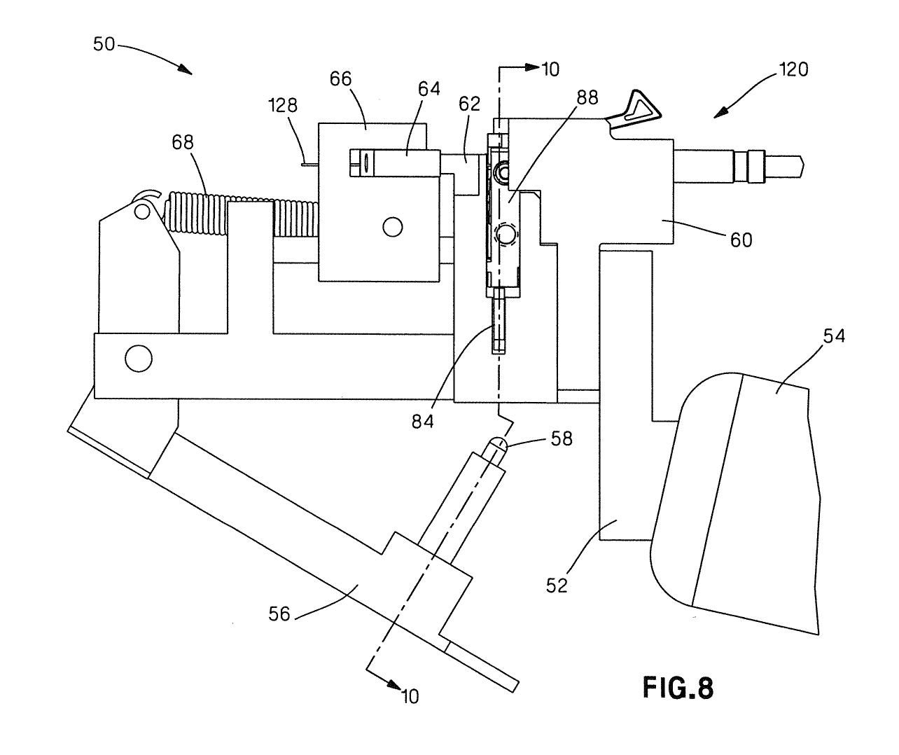

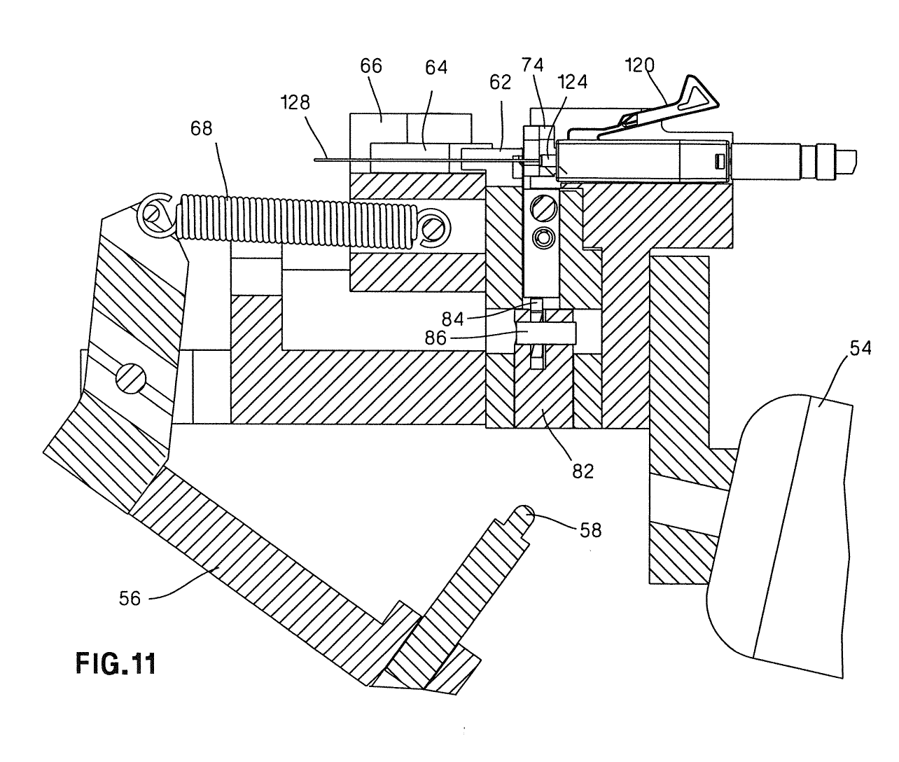

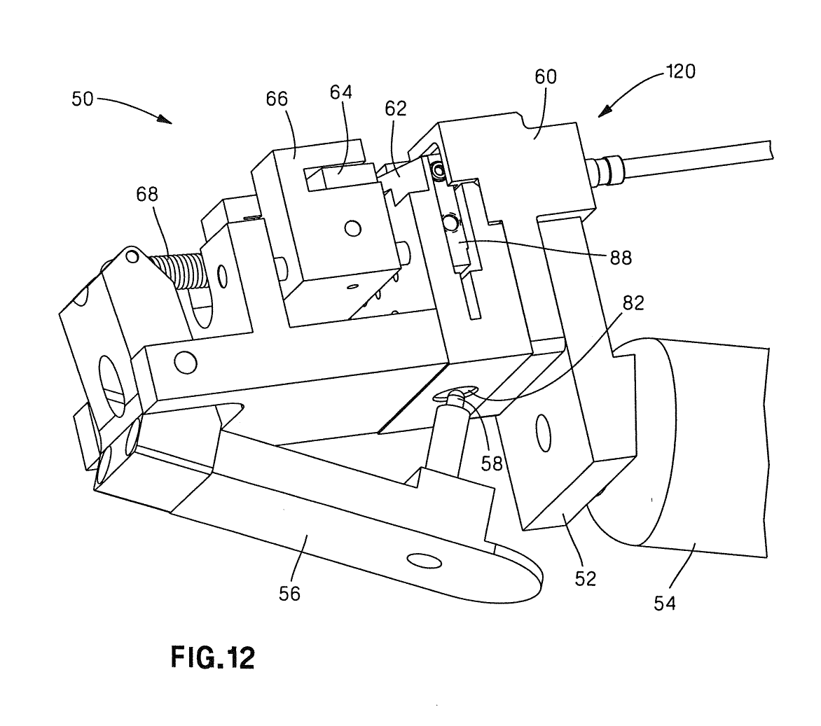

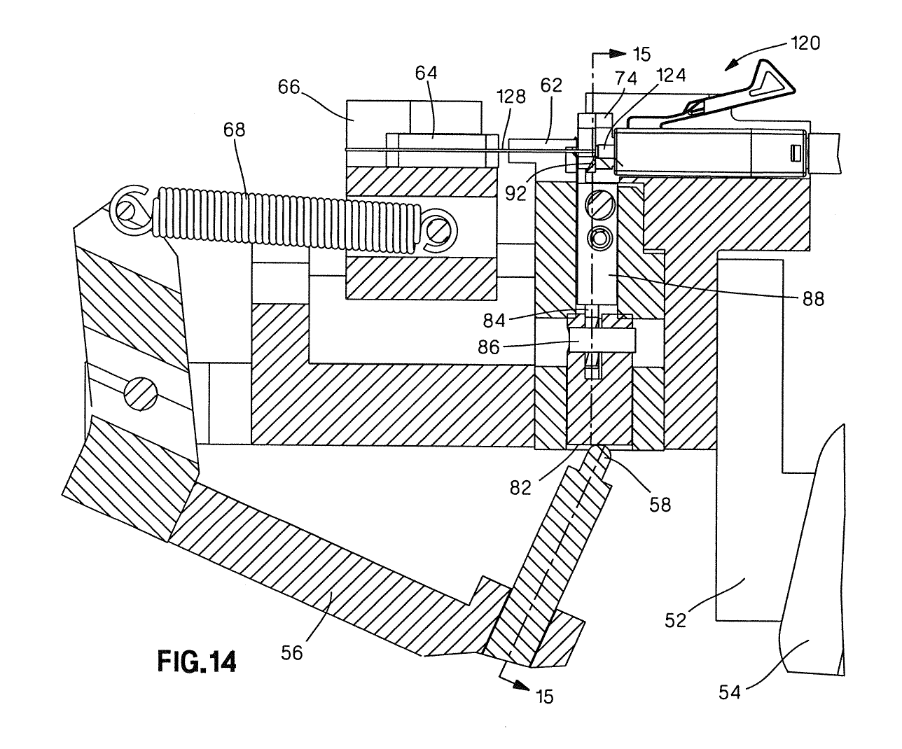

FIGS. 8-11 illustrate the fiber cleaving tool 50 prior to the lever 56 being activated. FIGS. 12-16 illustrate the fiber cleaving tool 50 with the lever 56 activated.

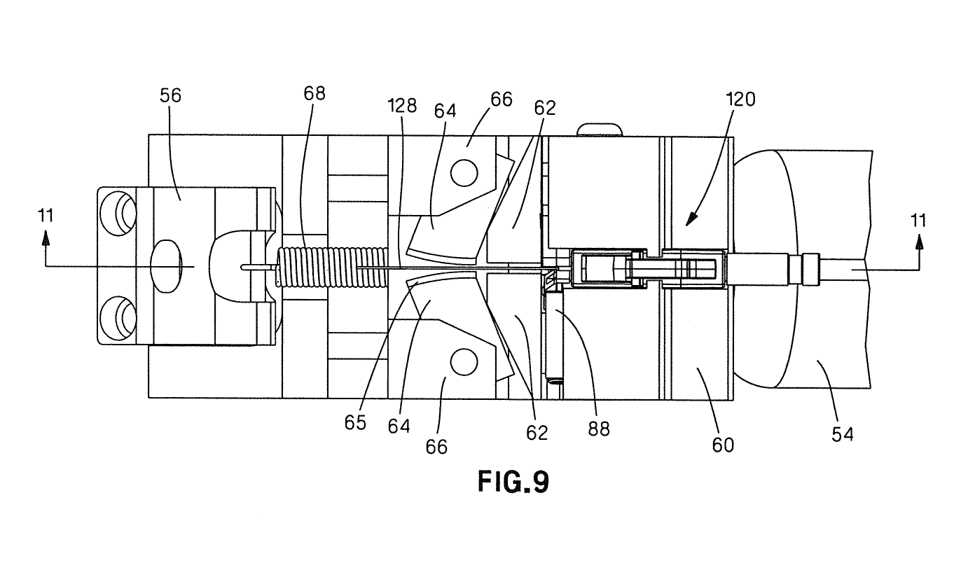

As discussed above, the connector 120 is positioned within pocket 70. Prior to the lever 56 being activated, the gripper opener cams 62 maintain the open position of the grippers 64 so the fiber optic cable 128 extending from the ferrule 124 may be installed. As illustrated in FIG. 9, the fiber optic cable 128 is positioned between the gripper opener cams 62 and the grippers 64. The grippers 64 include hard rubber pads 65 to prevent the fiber optic cable 128 from slipping under tension.

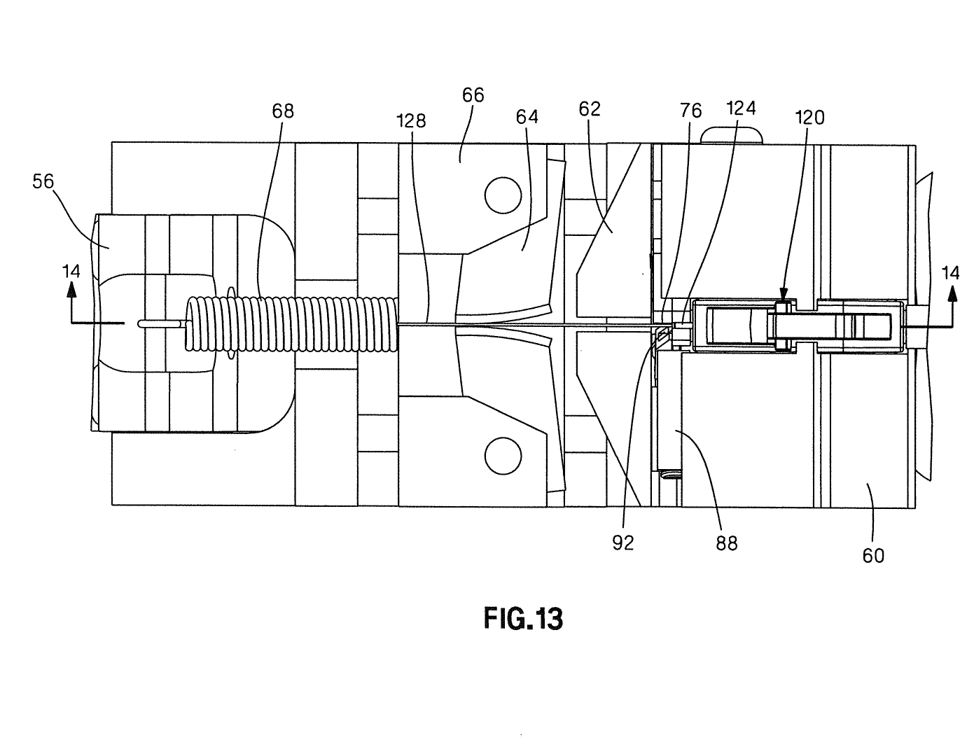

To activate the tool 50, the lever 56 is pressed toward the tool body 52. As the lever 56 is pressed, it pivots thereby exerting a force on the spring 68 which pulls the gripper carriage 66 and attached grippers 64 linearly away from the backbone 60. As illustrated in FIG. 13, when the gripper carriage 66 pulls away from the backbone 60, the spring loaded grippers 64 close since they are no longer held open by the gripper cam openers 62. The grippers 64 clamp the fiber optic cable 128. As the gripper carriage 66 is pulled linearly away from the backbone 60, the fiber optic cable 128 is tensioned.

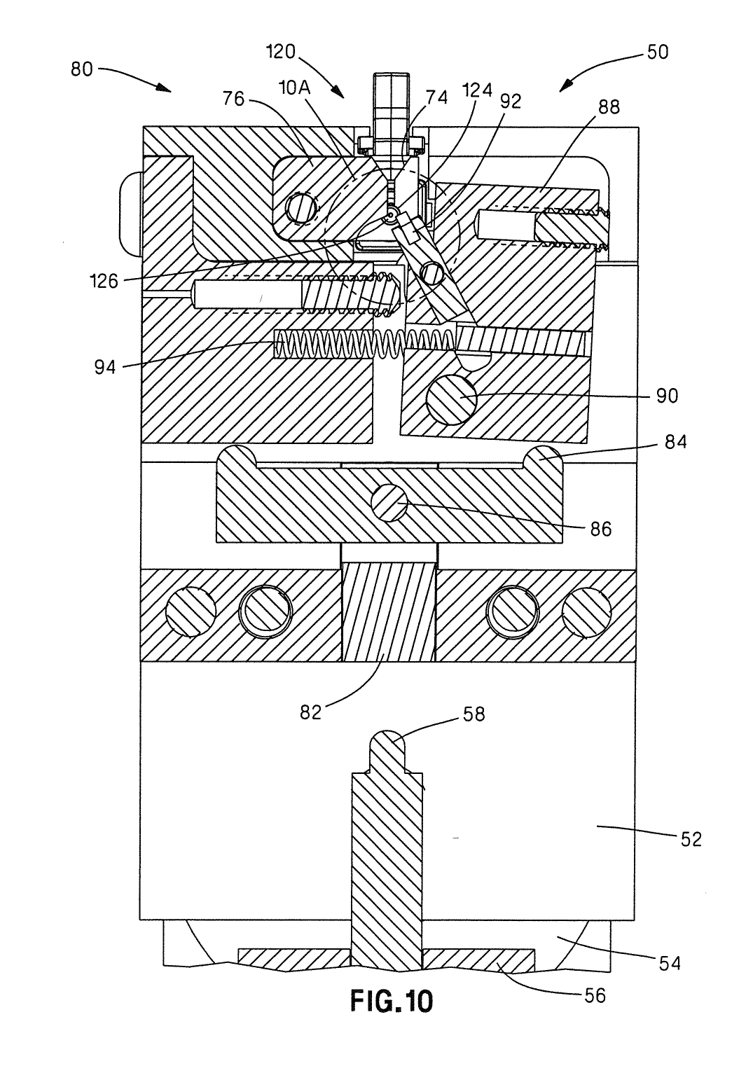

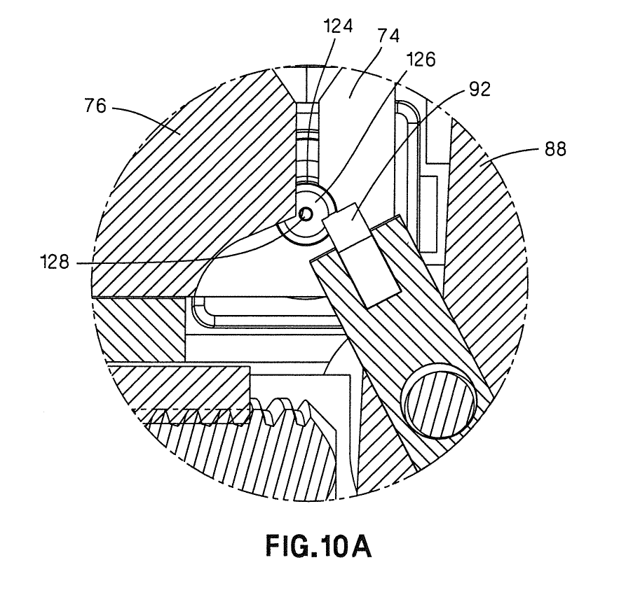

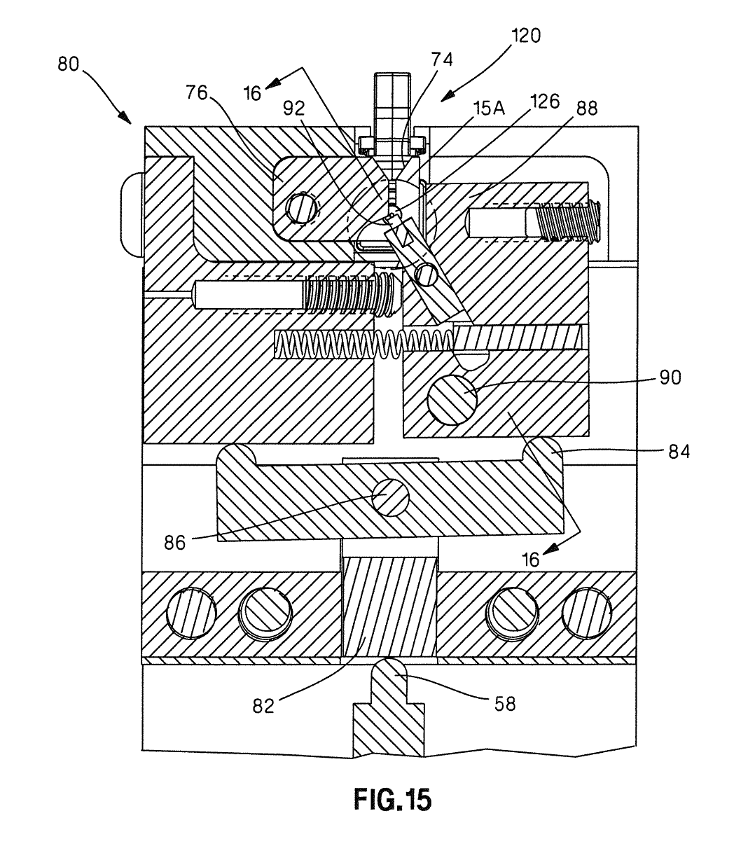

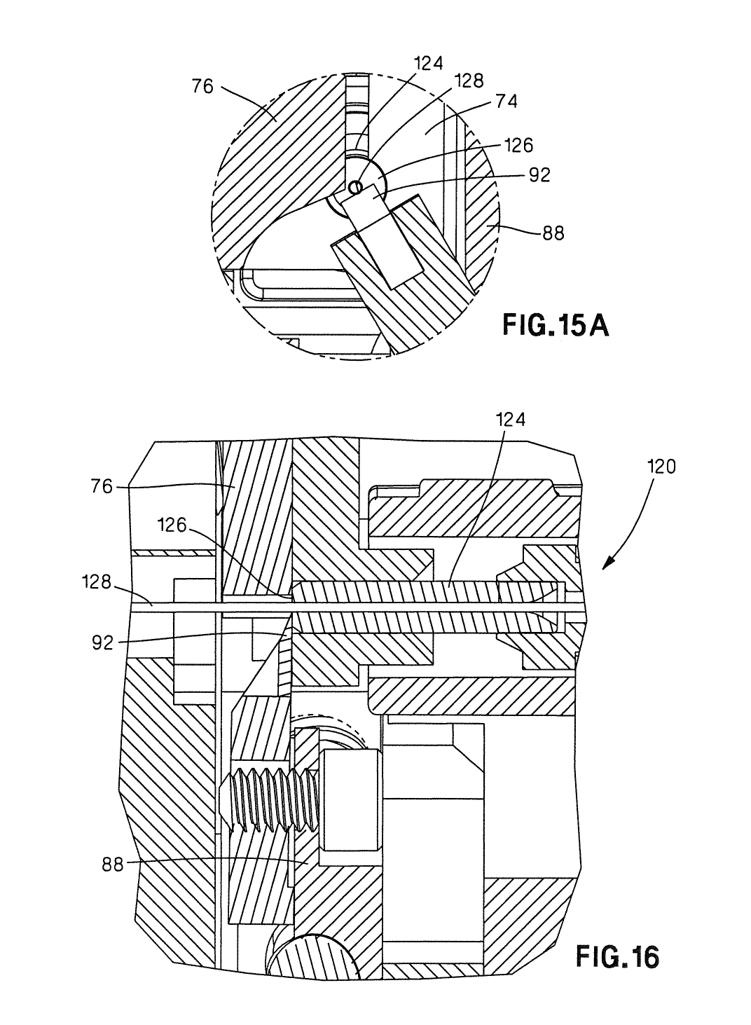

FIGS. 7, 10, and 10A illustrate the cleaving mechanism 80 of the fiber cleaving tool 50 prior to activation. FIGS. 15, 15A, and 16 illustrate the cleaving mechanism 80 of the fiber cleaving tool 50 after activation. As the lever 56 is completely depressed, the blade trigger 58 exerts a force on the plunger 82, which is free to move linearly. A swivel plate 84 is connected to the plunger 82 via a pin 86 so that the swivel plate 84 is free to pivot. The force exerted by the blade trigger 58 is transmitted through the plunger 82 to a swivel plate 84 and then the force is transmitted to the blade holder 88. The blade holder 88 is mounted such that it is free to pivot on the blade holder pivot pin 90. As the blade holder 88 pivots, the cleaving blade 92 swipes across the fiber optic cable 128 and scores it.

Since the fiber optic cable 128 is under tension, the score will propagate and the fiber optic cable 128 will break. As discussed above, the cleaving blade 92 is flush with the ferrule end face 126. As a result, the cleaving blade 92 is able to score the fiber optic cable 128 at a distance of 100 microns, or less, from the end of the ferrule 124.

Once the force on the lever 56 is relieved, the return spring 94 returns the entire cleaving mechanism 80 back to the initial or home position.

Thus to use the fiber cleaving tool 50 of the present invention, an operator inserts a connector 120 into the tool 50. The ferrule 124 is positioned in the ferrule holder 74 and stops at the ferrule stop plate 76. The connector snaps 72 engage the connector 120 to hold it in place in the tool body 52.

As illustrated in FIGS. 12-16, the operator presses the lever 56 which tensions the fiber optic cable 128 to a calibrated tension. The operator continues to press the lever 56 until the blade trigger 58 pushes the plunger 82 to advance the blade holder 88 with the cleaving blade 92. The cleaving blade 92 scores the fiber optic cable 128 which creates a crack that propagates under tension thereby severing the fiber optic cable 128. The gripper carriage 66 advances to the end of travel after the fiber optic cable 128 is severed. The connector 120 may now be removed from the tool 50. The operator also removes the scrap fiber optic cable from the tool 50. At this point the operator can release the lever 56 returning gripper carriage 66 to the home or original position.

Furthermore, while the particular preferred embodiments of the present invention have been shown and described, it will be obvious to those skilled in the art that changes and modifications may be made without departing from the teaching of the invention. The matter set forth in the foregoing description and accompanying drawings is offered by way of illustration only and not as limitation. The actual scope of the invention is intended to be defined in the following claims when viewed in their proper perspective based on the prior art.

1. A fiber cleaving tool comprising:
a tool body with a pocket and connector snaps extending over the pocket;
a tensioning mechanism and a cleaving mechanism positioned in the tool body;
a handle extending from a first end of the tool body; and
a lever pivotally connected to a second end of the tool body, the lever having a blade trigger for activating the cleaving mechanism to cleave a fiber extending from a connector positioned in the fiber cleaving tool.

2. The fiber cleaving tool of claim 1, wherein the tensioning mechanism comprising a gripper carriage with grippers and a spring connecting the lever and the gripper carriage.

3. The fiber cleaving tool of claim 2, wherein when the lever pivots towards a bottom of the tool body, the spring pulls the gripper carriage to close the grippers and tension the fiber extending from the connector positioned in the fiber cleaving tool.

4. The fiber cleaving tool of claim 3, wherein the grippers include pads for preventing the fiber from slipping under tension.

5. The fiber cleaving tool of claim 1, wherein the cleaving mechanism comprising a pivoting blade holder with a cleaving blade installed therein.

6. The fiber cleaving tool of claim 5, wherein the cleaving mechanism further comprising a swivel plate engaging the blade holder and a plunger pivotally connected to the swivel plate, wherein the blade trigger engages the plunger to pivot the swivel plate and the blade holder with the cleaving blade installed therein.

7. The fiber cleaving tool of claim 5, wherein the cleaving blade is in constant contact with an end of a ferrule extending from the connector.

8. The fiber cleaving tool of claim 5, wherein the cleaving blade is positioned to severe a fiber optic cable once the blade holder pivots.

9. The fiber cleaving tool of claim 1, further comprising a ferrule holder and a ferrule stop plate for positioning the connector installed in the fiber cleaving tool.

10. A method of severing a fiber optic cable with a fiber cleaving tool, the method comprising the steps of:
inserting a connector in a pocket in a tool body of the fiber cleaving tool;
positioning a fiber optic cable between grippers and gripper opener cams in the tool body;
activating a lever pivotally connected to the tool body to tension the fiber optic cable extending from the connector; and
engaging a cleaving mechanism to severe the fiber optic cable.

11. The method of claim 10, further comprising the step of positioning the connector in a ferrule holder with an end face of a ferrule engaging a ferrule stop plate.

12. The method of claim 10, wherein the step of tensioning the fiber optic cable further comprising pulling a spring loaded gripper carriage with attached grippers away from the gripper opener cams to tension the fiber optic cable positioned therebetween.

13. The method of claim 10, wherein the step of engaging a cleaving mechanism further comprising pivoting a blade holder and cleaving blade positioned therein, wherein the cleaving blade is in constant contact with an end face of a ferrule extending from the connector.

14. The method claim 14, wherein the cleaving blade scores the fiber optic cable flush with the ferrule's end face.
